(19) United States
(12) Patent Application Publication
(10) Pub. No.: US 2013/0113579 A1
(43) Pub. Date: May 9, 2013

(54) REMOTE-CONTROL RESETTING DEVICE

(71) Applicants: Jean-Christophe Barnas, Les Pontets (FR); Jean-Marc Mottier, Labergement-Ste-Marie (FR); Daniel Thevenin, Morez (FR)

(72) Inventors: Jean-Christophe Barnas, Les Pontets (FR); Jean-Marc Mottier, Labergement-Ste-Marie (FR); Daniel Thevenin, Morez (FR)

(73) Assignee: EATON INDUSTRIES MANUFACTURING GMBH, Morges (CH)

(21) Appl. No.: 13/642,140

(22) PCT Filed: Apr. 18, 2011
(86) PCT No.: PCT/EP11/56102

§ 371 Date: Dec. 19, 2012

(30) Foreign Application Priority Data
Apr. 20, 2010 (GB) 1006551.4

(51) Int. Cl. H01H 71/68

(52) U.S. Cl. CPC H01H 71/68
USPC 335/166

(57) ABSTRACT

A remote-control resetting device for an electrical safety device having a trip mechanism with a handle is provided. The resetting device includes: a housing; a solenoid having a movable core, the movable core being attached to an operating member for operating the handle of the electrical safety device; and a printed circuit board having a solenoid control circuit mounted thereon, the solenoid control circuit being electrically connected to the solenoid for controlling the movement of the core. The printed circuit board and the solenoid are arranged axially in the housing with the operating, member located at one end of the solenoid and the printed circuit board located at an opposite end of the solenoid.

### CROSS-REFERENCE TO RELATED APPLICATIONS

This patent application is a national stage entry under 35 U.S.C. § 371 of International Application No. PCT/EP2011/056102, filed Apr. 18, 2011, and claims priority to Great Britain Patent Application No. 1006551.4, filed Apr. 20, 2010. The International Application was published in English on Oct. 27, 2011, as WO 2011/131604 A1.

### FIELD

The present invention relates to a remote-control resetting device for an electrical safety device having a trip mechanism with handle. The invention also relates to an assembly of such a remote-control resetting device and an electrical safety device.

### BACKGROUND

An electrical safety device comprises devices which protect individuals against an electrical shock, e.g. a Residual Current Device (RCD) or a Residual Current Circuit Breaker (RCCB), devices which protect electrical circuits or electrical appliances from damage caused by overcurrent, e.g. circuit breakers (such as a MCB or a MCCB), as well as devices which provide both types of electrical safety, e.g. a Residual Current Breaker with Overcurrent protection (RCBO), as long as those devices are provided with a trip mechanism with an actuator lever.

Electrical safety devices having trip mechanisms with actuator levers are widely used. The actuator lever is used to manually trip and reset the electrical safety devices, such as a circuit breaker. It also indicates the status of the circuit breaker (On or Off/tripped). However, when the circuit breaker is used in remote or difficult accessible areas, such as on board of a train or in a telecom transmission tower, it will not be easy or sometimes even impossible to reset the actuator lever manually. In these circumstances it is also known to use a remote-control resetting device which can be operated remotely and which can reset the circuit breaker.

Usually a number of electrical safety devices are installed next to each other in a row, sometimes even with a number of rows above each other. In such arrangement the lateral and/or lower and upper walls of the safety devices can be in contact with adjacent safety devices. The row(s) of safety devices are fixed in a cabinet or enclosure. The space available in such a cabinet or enclosure is usually limited.

A solenoid operated remote resetting device is described in U.S. Pat. No. 5,894,398. The device contains a housing for enclosing a solenoid with moveable plunger. A spring is arranged between the solenoid and the plunger. The plunger is connected to an operating arm. The plunger, and thus the operating member, is biased by the spring into a first position in which the operating member is immediately adjacent a handle of the overload protection device. When current is applied to the solenoid, the plunger and operating arm are caused to move to the second position against the spring force engaging the handle and thereby resetting the tripped overload protection device. The housing of the resetting device also encloses a printed circuit board with a solenoid activation circuit. The printed circuit board extends parallel to the axis of the plunger from the solenoid to the operating member. The resetting device is attached to the lower side of the overload protection device with the printed circuit board arranged lateral to the solenoid and plunger assembly.

### SUMMARY

In an embodiment, the present invention provides a remote-control resetting device for an electrical safety device having a trip mechanism with a handle. The resetting device includes: a housing; a solenoid having a movable core, the movable core being attached to an operating member for operating the handle of the electrical safety device; and a printed circuit board having a solenoid control circuit mounted thereon, the solenoid control circuit being electrically connected to the solenoid for controlling the movement of the core. The printed circuit board and the solenoid are arranged axially in the housing with the operating member located at one end of the solenoid and the printed circuit board located at an opposite end of the solenoid.

### BRIEF DESCRIPTION OF THE SEVERAL VIEWS OF THE DRAWINGS

FIG. 1 shows a remote-controlled resetting device in accordance with an embodiment of the invention.

FIG. 2 shows an assembly of a remote-controlled resetting device and two circuit breakers in accordance with an embodiment of the invention.

FIG. 3 shows a force-displacement diagram of a solenoid for use in the resetting device according to a further embodiment of the invention.

### DETAILED DESCRIPTION

According to the invention there is provided a remote-control resetting device for an electrical safety device having a trip mechanism with handle, said resetting device comprising: a housing, a solenoid having a movable core, said movable core being attached to an operating member for operating the handle of the electrical safety device, a printed circuit board having a solenoid control circuit mounted thereon, said solenoid control circuit being electrically connected to the solenoid for controlling the movement of the core, wherein the printed circuit board and the solenoid are arranged axially in the housing with the operating member located at one end of the solenoid and the printed circuit board located at an opposite end of the solenoid.

A resetting device in accordance with this arrangement has a relatively small dimension in a direction perpendicular to the axis of the core. This allows installing multiple resetting devices adjacent to each other with their core axis in parallel arrangement.

In a further embodiment the printed circuit board is a flexible printed circuit board which is arranged at least partly around the moveable core of the solenoid. In this way the dimensions of the resetting device are further reduced both in a direction perpendicular to the plunger axis as well as in a direction along said axis. This does not only allow the installation of multiple resetting devices adjacent to each in a row, but also multiple rows above each other.

In order to fixate the printed circuit board in the housing, especially in situations of trains where the devices are subject to vibrations, the printed circuit board is preferably embedded in the housing by means of glue.

In a further embodiment the moveable core of the solenoid has a first and a second outer end, wherein said first outer end is directed to the printed circuit board and said second end is attached to the operating member located outwardly of a first wall of the housing. A washer is preferably arranged between the first wall of the housing and the operating member. It has been found that such a washer is capable of ensuring a correct operation of the resetting device. It prevents that any water or humid air between the operating member and the housing, especially under cold conditions, will have a negative effect on the movement of the plunger.

In still a further embodiment, the housing comprises a first housing part which accommodates the coil of the solenoid and a second housing part which accommodates the printed circuit board, wherein the second housing part is separated from the first housing part by a wall, and wherein the first outer end of the core extends through an opening in the wall into the second housing part. The printed circuit board with delicate electronic components is advantageously arranged in a separate housing part which is remote from the opening in the first wall through which the core extends to the operating member. This further minimizes the risk of water coming into contact with the printed circuit board.

The operating member may be a plate element having a square surface which is arranged to come into contact with the handle of an electrical safety device.

In another aspect of the invention, there is provided an assembly of a remote-control resetting device and an electrical safety device, wherein the operating member of the resetting device is arranged to come into contact with the handle of the electrical safety device.

In an embodiment, the assembly comprises one remote-control resetting device and at least two electrical safety devices each provided with a handle, wherein the operating member of the resetting device is arranged to come into contact with the handles of the safety devices. Two electrical safety devices may also have a common handle which is operated by on and the same resetting device. It also possible to reset a combination of two of those electrical safety devices with common handle by using just one resetting device.

The force-displacement characteristic of the solenoid ensures that the resetting device is powerful enough to re-set the safety device, but at the same time ensures that the safety device cannot be reset in the event that a short-circuit is still present.

The present invention will be discussed in more detail below, using a number of exemplary embodiments, with reference to the attached drawings.

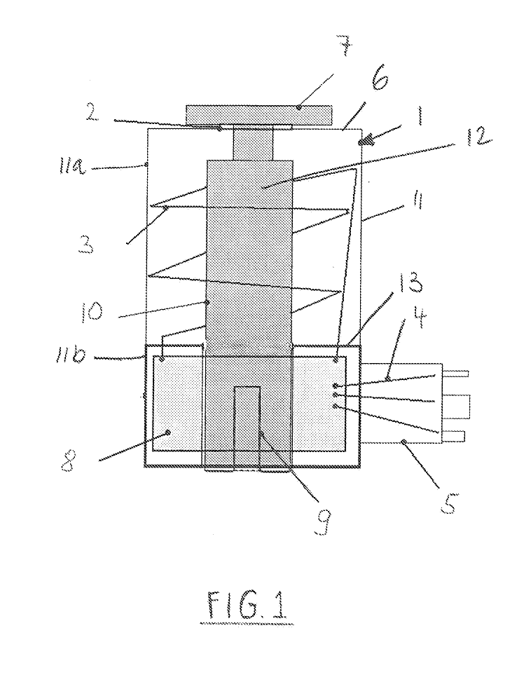

In FIG. 1 a remote-controlled resetting device 1 for an electrical safety device having a trip mechanism with handle is shown. The resetting device 1 comprises a housing 11 which accommodates a solenoid having a movable magnetic core 12 and a coil 3. The core 12 is attached to an operating member 7 for operating the handle of the electrical safety device.

The housing 11 comprises a first housing part 11a which accommodates the coil 3 of the solenoid and a second housing part 11b which accommodates a printed circuit board 8. The second housing part 11b is separated from the first housing part 11a by a wall 13. The magnetic core 12 of the solenoid extends which an outer end through an opening in the wall 13 into the second housing part 11b. Between the outer end of the core 12 and the second housing part 11b there is provided an extension 9 to prevent rotation of the core around its axis.

The printed circuit board 8 has a solenoid control circuit mounted thereon which is electrically connected to the solenoid coil 3 for controlling the movement of the magnetic core 12. The printed circuit board 8, the solenoid 3, 12 and the operating member 7 are arranged in an axial configuration which results in a compact design of the resetting device 1. It is further preferred to have a flexible printed circuit board 8 which can be bend to be wrapped around, or at least partly around, the moveable core 12 of the solenoid. This will further reduce the dimensions of the resetting device 1 in a direction perpendicular to the axis of the core 12.

The empty space in the housing 11b is preferably filled with glue or other electrically insulating embedding material to fixate and protect the printed circuit board 8 against vibrations.

The outer end of the magnetic core 12 which is attached to the operating member 7 extends outwardly of the housing 11a through an opening in wall 6. A washer 2 is arranged between the wall 6 of the housing 11 and the operating member 7. The operating member 7 is a plate element having a square surface which is arranged to come into contact with one or more handles of one or more electrical safety devices.

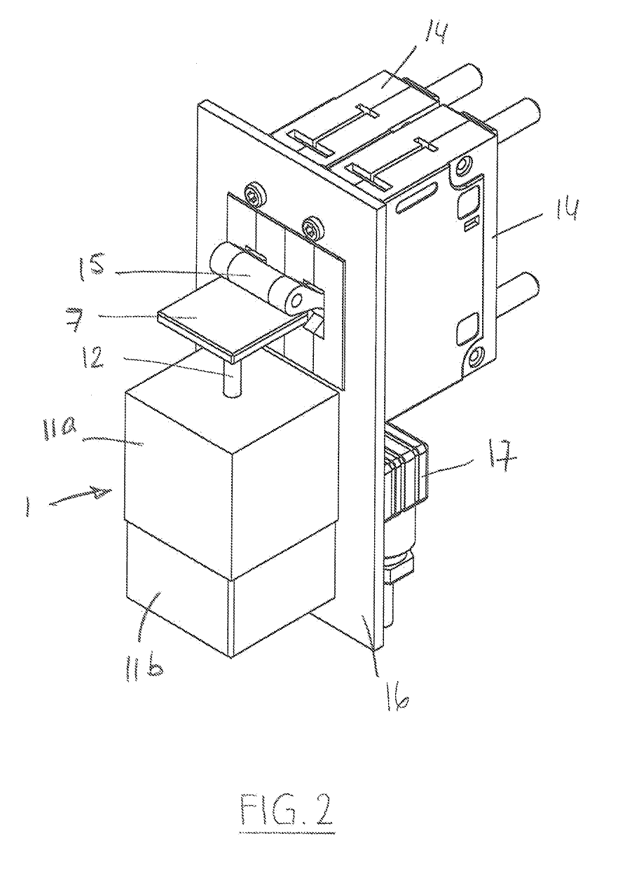

FIG. 2 shows the remote-control resetting device together with two circuit breakers 14 having a combined handle 15 or a 2-pole circuit breaker. The square surface of the operating member 7 is in contact with the full length of the combined handle 15. However, in another embodiment it is also possible to have two of such 2-pole circuit breakers adjacent each other operated by only one resetting device 1 wherein the square surface of the operating member 7 is then partly in contact with the handle of the first 2-pole circuit breaker and partly in contact with the handle of the second 2-pole circuit breaker. In that case the handles are only contacted over a part of their length.

The remote-control resetting device can be attached to a wall 16 of for example an electrical cabinet (not shown). The circuit breakers 14 are attached on the back side of this wall 16 while the handles 15 of the circuit breakers 14 extend through apertures in the wall 16 to allow access from the front side of the cabinet. Also on the back side of the wall there is provided a connector 17 for making the required connection to the resetting device 1.

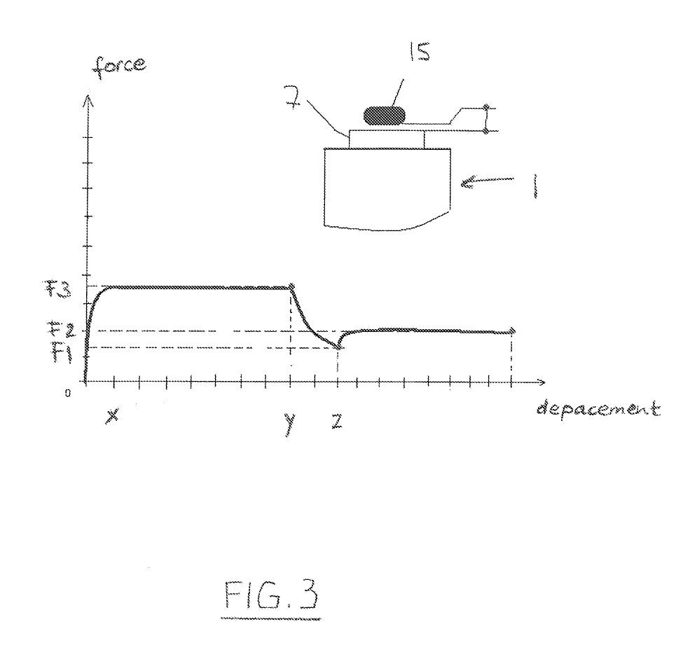

FIG. 3 shows the force-displacement diagram of the solenoid 3, 12. It represents the force to be applied on the handle 15 of the breaker in relation to its move distance. Before displacing the operating member 7 there is some play as indicted in FIG. 3 between the operating member 7 and the lower surface of the handle 15. This will help the electro-magnet to obtain speed and force. During this stage the force is established as quickly as possible. When the handle 15 is displaced over a certain distance “x”, further displacement will continue without requiring any increase in force. The force is constant at level F3 and should be large enough to move the handle against the breaker mechanism. At distance “y” the handle 15 has reached its tilting point resulting in further rotation of the handle 15 and decreasing force (from F3 to F1) until the breaker handle reaches its equilibrium in “z”. The equilibrium is not enough to maintain the handle of the breaker into its “ON” or reset position. The handle 15 should be moved over its equilibrium to block it regarding the breaker trip mechanism and maintain it ON position. For that reason, the breaker will be moved further under applying additional force “F2”. Finally, the force will be maintained at level F2 which should be lower than the tripping force to ensure correct working of the breaker 14.

Having thus described the invention with reference to preferred embodiments, it is to be appreciated that modifications and variations are possible to the described arrangements without departure from the scope of the invention.

1-10. (canceled)

11. A remote-control resetting device for an electrical safety device having a trip mechanism with a handle, the resetting device comprising:
a housing;
a solenoid having a movable core, the movable core being attached to an operating member for operating the handle of the electrical safety device; and
a printed circuit board having a solenoid control circuit mounted thereon, the solenoid control circuit being electrically connected to the solenoid for controlling the movement of the core;
wherein the printed circuit board and the solenoid are arranged axially in the housing with the operating member located at one end of the solenoid and the printed circuit board located at an opposite end of the solenoid.

12. The remote-control resetting device according to clam 11, wherein the printed circuit board is a flexible printed circuit board which is arranged at least partly around the moveable core of the solenoid.

13. The remote-control resetting device according to clam 11, wherein the printed circuit board is embedded in the housing by glue.

14. The remote-control resetting device according to clam 11, wherein the moveable core of the solenoid has a first outer end which is directed to the printed circuit board and a second outer end which is attached to the operating member located outwardly of a first wall of the housing.

15. The remote-control resetting device according to claim 14, further comprising a washer between the first wall of the housing and the operating member.

16. The remote control resetting device according to claim 11, wherein the housing comprises:
a first housing part which accommodates the coil of the solenoid; and
a second housing part which accommodates the printed circuit board;
wherein the second housing part is separated from the first housing part by a wall, and wherein a first outer end of the core extends through an opening in the wall into the second housing part.

17. The remote-control resetting device according to claim 11, wherein the operating member is a plate having a square surface which is arranged to come into contact with the handle of the electrical safety device.

18. An assembly, comprising:
a remote-control resetting device for an electrical safety device having a trip mechanism with a handle, the resetting device comprising:
a housing;
a solenoid having a movable core, the movable core being attached to an operating member; and
a printed circuit board having a solenoid control circuit mounted thereon, the solenoid control circuit being electrically connected to the solenoid for controlling the movement of the core;
wherein the printed circuit board and the solenoid are arranged axially in the housing with the operating member located at one end of the solenoid and the printed circuit board located at an opposite end of the solenoid; and
the electrical safety device, wherein the operating member of the resetting device is arranged to come into contact with the handle of the electrical safety device.

19. The assembly according to claim 18, comprising at least two electrical safety devices each having a handle, wherein the operating member of the resetting device is arranged to come into contact with the handles of the at least two safety devices.

20. The assembly according to claim 18, wherein the solenoid has a force-displacement distribution where the force needed to move the solenoid varies based on the displacement of the solenoid.
